(19) United States
(12) Patent Application Publication
(10) Pub. No.: US 2014/0328264 A1
(43) Pub. Date: Nov. 6, 2014

(54) SYSTEMS AND METHODS FOR COORDINATION MESSAGING USING HIGH EFFICIENCY WIFI

(71) Applicant: QUALCOMM Incorporated, San Diego, CA (US)

(72) Inventors: Simone Merlin, Solana Beach, CA (US); Gwendolyn Denise Barriac, Encinitas, CA (US); Rahul Tandra, San Diego, CA (US); Yan Zhou, San Diego, CA (US); Hemanth Sampath, San Diego, CA (US); Bin Tian, San Diego, CA (US); Sameer Vermani, San Diego, CA (US)

(73) Assignee: QUALCOMM Incorporated, San Diego, CA (US)

(21) Appl. No.: 14/266,680

(22) Filed: Apr. 30, 2014

Related U.S. Application Data
(60) Provisional application No. 61/819,407, filed on May 3, 2013.

(51) Int. Cl. H04W 74/04

(52) U.S. Cl. CPC H04W 74/04
USPC 370/329

(57) ABSTRACT

Systems, methods, and devices for coordinating access to a shared medium are described herein. In some aspects, a method includes receiving information at an access point. The method further includes modifying, based on the received information, the use of the shared medium by one or more wireless devices to reduce the likelihood that the wireless devices are subject to interference. The method may further include determining whether one or more wireless devices is subject to interference with another wireless device in the wireless network. The method may further include identifying the one or more wireless devices that is subject to interference.

### CROSS-REFERENCE TO RELATED APPLICATIONS

This application claims the benefit under 35 U.S.C. §119(e) of U.S. Provisional Application No. 61/819,407, filed May 3, 2013, which is hereby expressly incorporated by reference in its entirety.

### BACKGROUND

1. Field

The present application relates generally to wireless communications, and more specifically to systems, methods, and devices for coordination messaging using high efficiency WiFi.

2. Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, SONET (Synchronous Optical Networking), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc. frequency bands. Wireless networks advantageously facilitate user mobility and rapid field deployment when compared to fixed wired networks.

However, multiple wireless networks may exist in the same building, in nearby buildings, and/or in the same outdoor area. The prevalence of multiple wireless networks may cause interference, reduced throughput (e.g., because each wireless network is operating in the same area and/or spectrum), and/or prevent certain devices from communicating. Thus, improved systems, methods, and devices for communicating when wireless networks are densely populated are desired.

### SUMMARY

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description” one will understand how the features of this invention provide advantages that include improved communications between access points and stations in a wireless network.

One aspect of this disclosure provides a method for coordinating access to a shared medium between an access point (AP) in a first basic service set (BSS) and an access point (AP) in a second basic service set (BSS). Each BSS includes one or more wireless devices. The method includes receiving information at one of the APs associated with the first or second BSSs, and modifying, based on the received information, the use of the shared medium by one or more wireless devices to reduce the likelihood that the one or more wireless devices is subject to interference.

Another aspect of this disclosure is an apparatus for coordinating access to a shared medium between an access point (AP) in a first basic service set (BSS) and an access point (AP) in a second basic service set (BSS). Each BSS includes one or more wireless devices. The apparatus includes means for receiving information at one of the APs associated with the first or second BSSs, and means for modifying the use of the shared medium by one or more wireless devices to reduce the likelihood that the one or more wireless devices is subject to interference.

Another aspect of this disclosure is a non-transitory computer-readable medium comprising code that, when executed, causes an apparatus to receive information at one of the APs associated with the first or second BSSs, and modify the use of the shared medium by one or more wireless devices to reduce the likelihood that the one or more wireless devices is subject to interference.

Another aspect of this disclosure is an apparatus for coordinating access to a shared medium between an access point (AP) in a first basic service set (BSS) and an access point (AP) in a second basic service set (BSS). Each BSS includes one or more wireless devices. The apparatus includes a receiver configured to receive information associated with the first or second BSSs, and a controller configured to modify the use of the shared medium by one or more wireless devices to reduce the likelihood that the one or more wireless devices is subject to interference.

### BRIEF DESCRIPTION OF THE DRAWINGS

FIG. 1 shows an exemplary wireless communication system in which aspects of the present disclosure may be employed.

FIG. 2A shows a wireless communication system in which multiple wireless communication networks are present.

FIG. 2B shows another wireless communication system in which multiple wireless communication networks are present.

FIG. 3 shows frequency multiplexing techniques that may be employed within the wireless communication systems of FIGS. 1 and 2B.

FIG. 4 shows a functional block diagram of an exemplary wireless device that may be employed within the wireless communication systems of FIGS. 1, 2B, and 3.

FIG. 5 shows a wireless communication system in which aspects of the present disclosure may be employed.

FIG. 6A is a representation of a management frame that may be employed within the wireless communication systems disclosed herein.

FIG. 6B is a representation of an action frame that may be employed within the wireless communication systems disclosed herein.

FIG. 6C is a representation of a GAS frame that may be employed within the wireless communication systems disclosed herein.

FIG. 6D is a representation of a frame including an HTC control field that includes a reserve bit that may be employed within the wireless communication systems disclosed herein.

FIG. 7 is a representation of a modified RPS information element defined by 802.11ah that may be employed within the wireless communication systems disclosed herein.

FIG. 8 is a representation of a modified advertisement frame action field and of a TXOP reservation field format defined by 802.11 as that may be employed within the wireless communication systems disclosed herein.

FIG. 9 is an exemplary wireless communication system employing time coordination for STA communication.

FIG. 10 is an exemplary wireless communication system employing frequency coordination for STA communication.

FIG. 11 is a flowchart of a method for coordinating access to a shared medium between an access point in a first basic service set and an access point in a second basic service set, each basic service set including one or more wireless devices.

### DETAILED DESCRIPTION

Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Popular wireless network technologies may include various types of wireless local area networks (WLANs). A WLAN may be used to interconnect nearby devices together, employing widely used networking protocols. The various aspects described herein may apply to any communication standard, such as a wireless protocol.

In some aspects, wireless signals may be transmitted according to a high-efficiency 802.11 protocol using orthogonal frequency-division multiplexing (OFDM), direct-sequence spread spectrum (DSSS) communications, a combination of OFDM and DSSS communications, or other schemes. Implementations of the high-efficiency 802.11 protocol may be used for Internet access, sensors, metering, smart grid networks, or other wireless applications. Advantageously, aspects of certain devices implementing the high-efficiency 802.11 protocol using the techniques disclosed herein may include allowing for increased peer-to-peer services (e.g., Miracast, WiFi Direct Services, Social WiFi, etc.) in the same area, supporting increased per-user minimum throughput requirements, supporting more users, providing improved outdoor coverage and robustness, and/or consuming less power than devices implementing other wireless protocols.

In some implementations, a WLAN includes various devices which are the components that access the wireless network. For example, there may be two types of devices: access points (“APs”) and clients (also referred to as stations, or “STAs”). In general, an AP may serve as a hub or base station for the WLAN and an STA serves as a user of the WLAN. For example, an STA may be a laptop computer, a personal digital assistant (PDA), a mobile phone, etc. In an example, an STA connects to an AP via a WiFi (e.g., IEEE 802.11 protocol) compliant wireless link to obtain general connectivity to the Internet or to other wide area networks. In some implementations an STA may also be used as an AP.

An access point (“AP”) may also comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology.

A station “STA” may also comprise, be implemented as, or known as an access terminal (“AT”), a subscriber station, a subscriber unit, a mobile station, a remote station, a remote terminal, a user terminal, a user agent, a user device, user equipment, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

As discussed above, certain of the devices described herein may implement a high-efficiency 802.11 standard, for example. Such devices, whether used as an STA or AP or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine-to-machine communications.

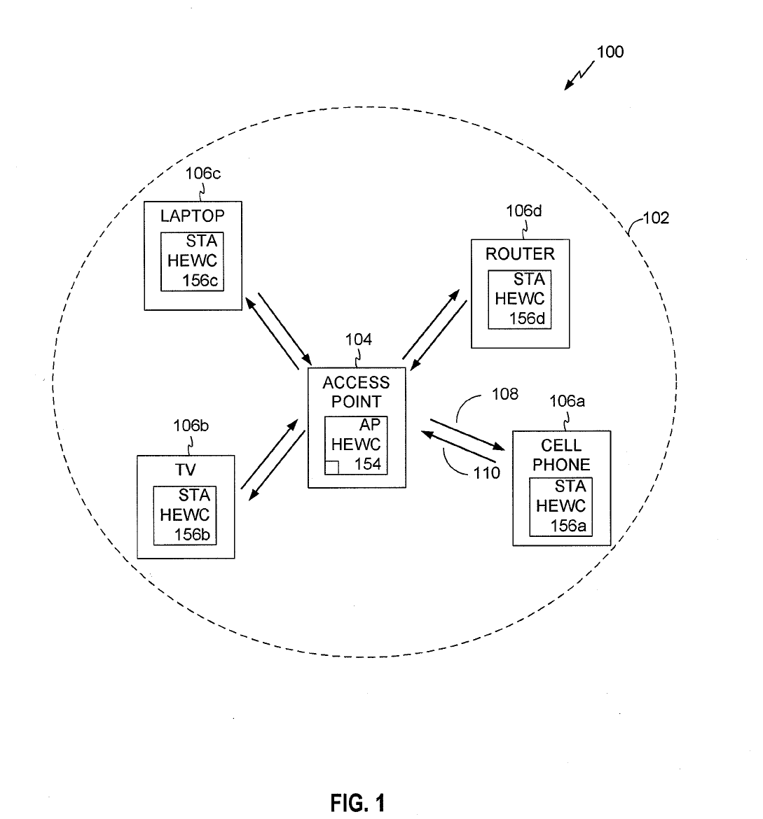

FIG. 1 shows an exemplary wireless communication system 100 in which aspects of the present disclosure may be employed. The wireless communication system 100 may operate pursuant to a wireless standard, for example a high-efficiency 802.11 standard. The wireless communication system 100 may include an AP 104, which communicates with STAs 106.

A variety of processes and methods may be used for transmissions in the wireless communication system 100 between the AP 104 and the STAs 106. For example, signals may be sent and received between the AP 104 and the STAs 106 in accordance with OFDM/OFDMA techniques. If this is the case, the wireless communication system 100 may be referred to as an OFDM/OFDMA system. Alternatively, signals may be sent and received between the AP 104 and the STAs 106 in accordance with code division multiple access (CDMA) techniques. If this is the case, the wireless communication system 100 may be referred to as a CDMA system.

A communication link that facilitates transmission from the AP 104 to one or more of the STAs 106 may be referred to as a downlink (DL) 108, and a communication link that facilitates transmission from one or more of the STAs 106 to the AP 104 may be referred to as an uplink (UL) 110. Alternatively, a downlink 108 may be referred to as a forward link or a forward channel, and an uplink 110 may be referred to as a reverse link or a reverse channel.

The AP 104 may act as a base station and provide wireless communication coverage in a basic service area (BSA) 102. The AP 104 along with the STAs 106 associated with the AP 104 and that use the AP 104 for communication may be referred to as a basic service set (BSS). It should be noted that the wireless communication system 100 may not have a central AP 104, but rather may function as a peer-to-peer network between the STAs 106. Accordingly, the functions of the AP 104 described herein may alternatively be performed by one or more of the STAs 106.

In some aspects, a STA 106 may be required to associate with the AP 104 in order to send communications to and/or receive communications from the AP 104. In one aspect, information for associating is included in a broadcast by the AP 104. To receive such a broadcast, the STA 106 may, for example, perform a broad coverage search over a coverage region. A search may also be performed by the STA 106 by sweeping a coverage region in a lighthouse fashion, for example. After receiving the information for associating, the STA 106 may transmit a reference signal, such as an association probe or request, to the AP 104. In some aspects, the AP 104 may use backhaul services, for example, to communicate with a larger network, such as the Internet or a public switched telephone network (PSTN).

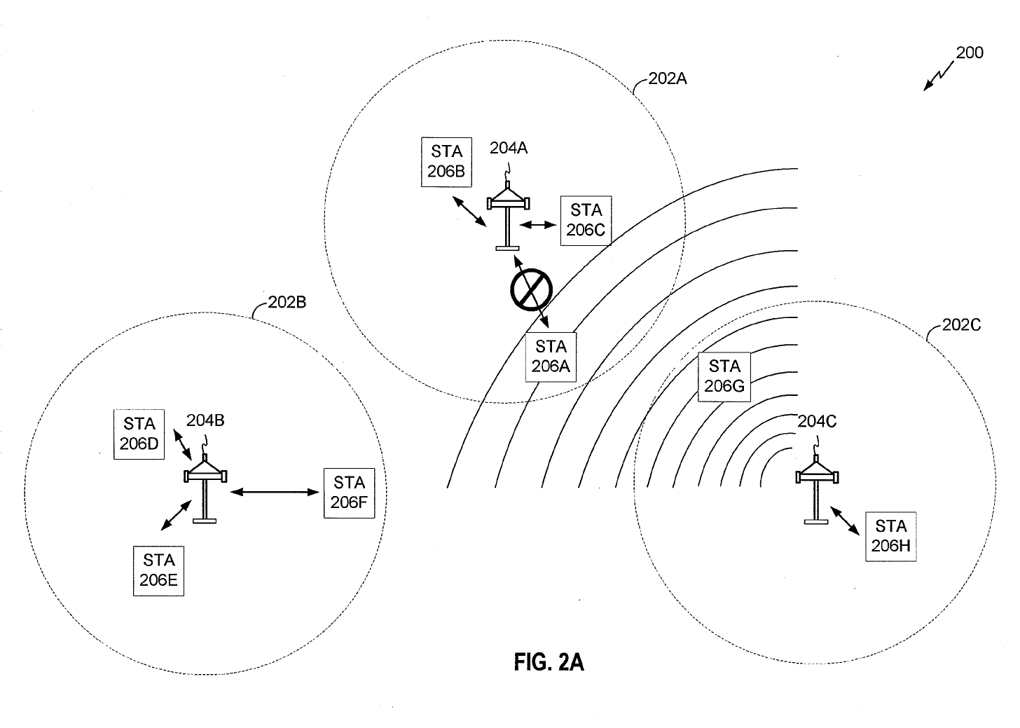

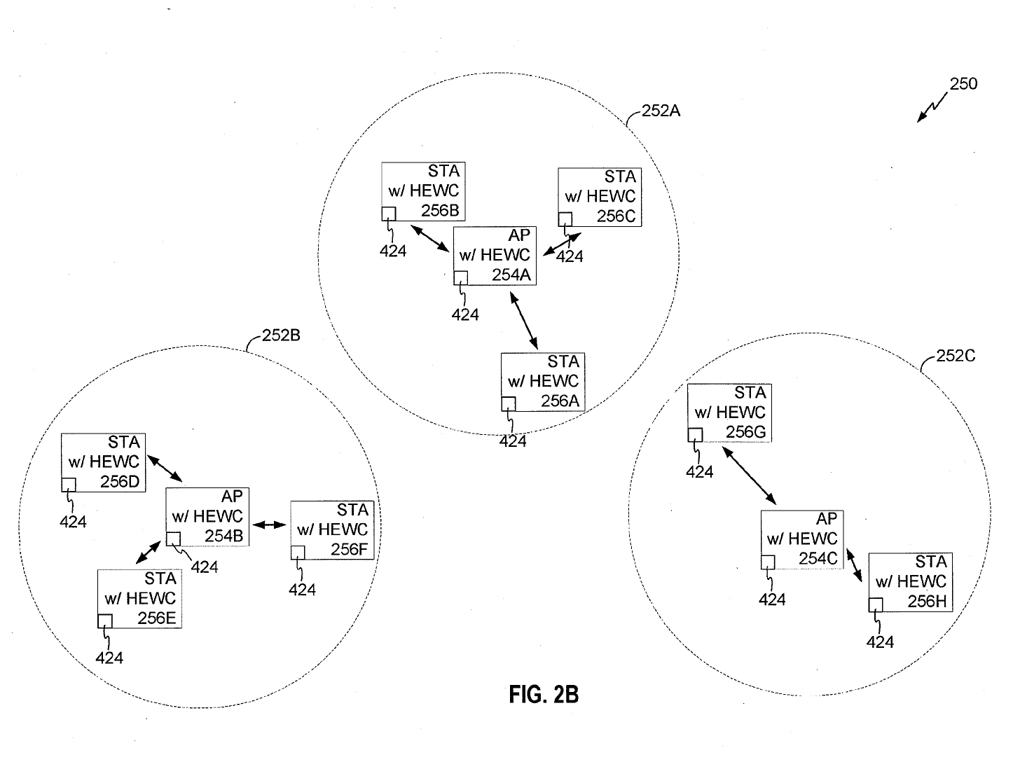

In an embodiment, the AP 104 includes an AP high-efficiency wireless component (HEWC) 154. The AP HEWC 154 may perform some or all of the operations described herein to enable communications between the AP 104 and the STAs 106 using the high-efficiency 802.11 protocol. The functionality of the AP HEWC 154 is described in greater detail below with respect to FIGS. 2B, 3, 4, and 5.

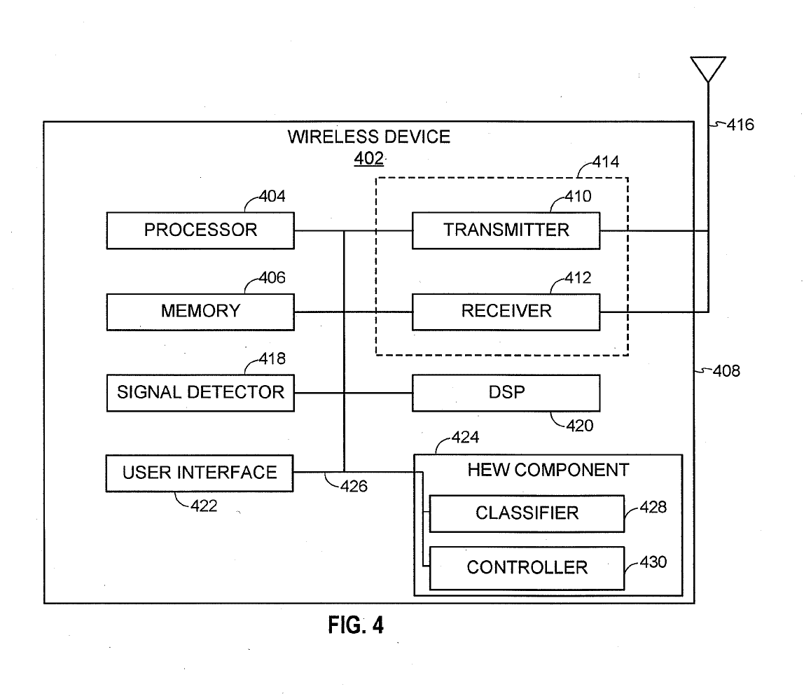

Alternatively or in addition, the STAs 106 may include a STA HEWC 156. The STA HEWC 156 may perform some or all of the operations described herein to enable communications between the STAs 106 and the AP 104 using the high-frequency 802.11 protocol. The functionality of the AP HEWC 154 and the STA HEWC 156 are described in greater detail below with respect to FIGS. 2B, 3, 4, and 5, and especially with respect to the HEW component 424 of FIG. 4.

In some circumstances, a BSA may be located near other BSAs. For example, FIG. 2A shows a wireless communication system 200 in which multiple wireless communication networks are present. As illustrated in FIG. 2A, BSAs 202A, 202B, and 202C may be physically located near each other. Despite the close proximity of the BSAs 202A-C, the APs 204A-C and/or STAs 206A-H may each communicate using the same spectrum. Thus, if a device in the BSA 202C (e.g., the AP 204C) is transmitting data, devices outside the BSA 202C (e.g., APs 204A-B or STAs 206A-F) may sense the communication on the medium.

Generally, wireless networks that use a regular 802.11 protocol (e.g., 802.11a, 802.11b, 802.11g, 802.11n, etc.) operate under a carrier sense multiple access (CSMA) mechanism for medium access. According to CSMA, devices sense the medium and only transmit when the medium is sensed to be idle. Thus, if the APs 204A-C and/or STAs 206A-H are operating according to the CSMA mechanism and a device in the BSA 202C (e.g., the AP 204C) is transmitting data, then the APs 204A-B and/or STAs 206A-F outside of the BSA 202C may not transmit over the medium even though they are part of a different BSA.

FIG. 2A illustrates such a situation. As illustrated in FIG. 2A, AP 204C is transmitting over the medium. The transmission is sensed by STA 206G, which is in the same BSA 202C as the AP 204C, and by STA 206A, which is in a different BSA than the AP 204C. While the transmission may be addressed to the STA 206G and/or only STAs in the BSA 202C, STA 206A nonetheless may not be able to transmit or receive communications (e.g., to or from the AP 204A) until the AP 204C (and any other device) is no longer transmitting on the medium. Although not shown, the same may apply to STAs 206D-F in the BSA 202B and/or STAs 206B-C in the BSA 202A as well (e.g., if the transmission by the AP 204C is stronger such that the other STAs can sense the transmission on the medium).

The use of the CSMA mechanism then creates inefficiencies because some APs or STAs outside of a BSA may be able to transmit data without interfering with a transmission made by an AP or STA in the BSA. As the number of active wireless devices continues to grow, the inefficiencies may begin to significantly affect network latency and throughput. For example, significant network latency issues may appear in apartment buildings, in which each apartment unit may include an access point and associated stations. In fact, each apartment unit may include multiple access points, as a resident may own a wireless router, a video game console with wireless media center capabilities, a television with wireless media center capabilities, a cell phone that can act like a personal hot-spot, and/or the like. Correcting the inefficiencies of the CSMA mechanism may then be vital to avoid latency and throughput issues and overall user dissatisfaction.

Such latency and throughput issues may not even be confined to residential areas. For example, multiple access points may be located in airports, subway stations, and/or other densely-populated public spaces. Currently, WiFi access may be offered in these public spaces, but for a fee. If the inefficiencies created by the CSMA mechanism are not corrected, then operators of the wireless networks may lose customers as the fees and lower quality of service begin to outweigh any benefits.

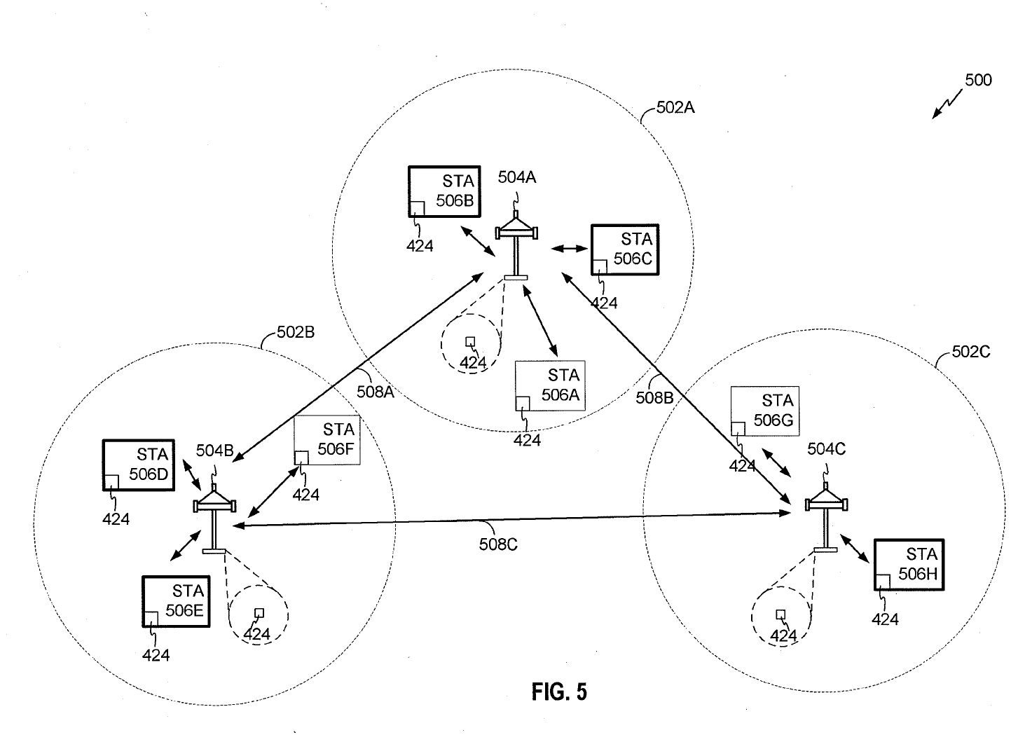

Accordingly, the high-efficiency 802.11 protocol described herein may allow for devices to operate under a modified mechanism that minimizes these inefficiencies and increases network throughput. Such a mechanism is described below with respect to FIGS. 2B, 3, and 4. Additional aspects of the high-efficiency 802.11 protocol are described below with respect to FIGS. 5-9.

FIG. 2B shows a wireless communication system 250 in which multiple wireless communication networks are present. Unlike the wireless communication system 200 of FIG. 2A, the wireless communication system 250 may operate pursuant to the high-efficiency 802.11 standard discussed herein. The wireless communication system 250 may include an AP 254A, an AP 254B, and an AP 254C. The AP 254A may communicate with STAs 256A-C, the AP 254B may communicate with STAs 256D-F, and the AP 254C may communicate with STAs 256G-H.

A variety of processes and methods may be used for transmissions in the wireless communication system 250 between the APs 254A-C and the STAs 256A-H. For example, signals may be sent and received between the APs 254A-C and the STAs 256A-H in accordance with OFDM/OFDMA techniques or CDMA techniques.

The AP 254A may act as a base station and provide wireless communication coverage in a BSA 252A. The AP 254B may act as a base station and provide wireless communication coverage in a BSA 252B. The AP 254C may act as a base station and provide wireless communication coverage in a BSA 252C. It should be noted that each BSA 252A, 252B, and/or 252C may not have a central AP 254A, 254B, or 254C, but rather may allow for peer-to-peer communications between one or more of the STAs 256A-H. Accordingly, the functions of the AP 254A-C described herein may alternatively be performed by one or more of the STAs 256A-H.

In an embodiment, the APs 254A-C and/or STAs 256A-H include a high-efficiency wireless component 424, as will be described in more detail in connection with FIG. 4. As described herein, the high-efficiency wireless component 424 may enable communications between the APs and STAs using the high-efficiency 802.11 protocol. In particular, the high-efficiency wireless component may enable the APs 254A-C and/or STAs 256A-H to use a modified mechanism that minimizes the inefficiencies of the CSMA mechanism (e.g., enables concurrent communications over the medium in situations in which interference would not occur).

As illustrated in FIG. 2B, the BSAs 252A-C are physically located near each other. When, for example, AP 254A and STA 256B are communicating with each other, the communication may be sensed by other devices in BSAs 252B-C. However, the communication may only interfere with certain devices, such as STA 256F and/or STA 256G. Under CSMA, AP 254B would not be allowed to communicate with STA 256E even though such communication would not interfere with the communication between AP 254A and STA 256B. Thus, the high-efficiency 802.11 protocol operates under a modified mechanism that differentiates between devices that can communicate concurrently and devices that cannot communicate concurrently. Such classification of devices may be performed by the high-efficiency wireless component 424 in the APs 254A-C and/or the STAs 256A-H.

In an embodiment, the determination of whether a device can communicate concurrently with other devices is based on a location of the device. For example, a STA that is located near an edge of the BSA may be in a state or condition such that the STA cannot communicate concurrently with other devices. Such STAs may be termed “cell edge” STAs. As illustrated in FIG. 2A, STAs 206A, 206F, and 206G may be devices that are in a state or condition in which they cannot communicate concurrently with other devices. Likewise, a STA that is located near the center of the BSA may be in a station or condition such that the STA can communicate with other devices. Such STAs may be termed “cell center” STAs. As illustrated in FIG. 2, STAs 206B, 206C, 206D, 206E, and 206H may be devices that are in a state or condition in which they can communicate concurrently with other devices. Note that the classification of devices is not permanent. Devices may transition between being in a state or condition such that they can communicate concurrently and being in a state or condition such that they cannot communicate concurrently (e.g., devices may change states or conditions when in motion, when associating with a new AP, when disassociating, etc.).

Furthermore, devices may be configured to behave differently based on whether they are ones that are or are not in a state or condition to communicate concurrently with other devices. For example, devices that are in a state or condition such that they can communicate concurrently may communicate within the same spectrum. However, devices that are in a state or condition such that they cannot communicate concurrently may employ certain techniques, such as spatial multiplexing or frequency domain multiplexing, in order to communicate over the medium. The controlling of the behavior of the devices may be performed by the high-efficiency wireless component in the APs 254A-C and/or the STAs 256A-H.

In an embodiment, devices that are in a state or condition such that they cannot communicate concurrently use spatial multiplexing techniques to communicate over the medium. For example, power and/or other information may be embedded within the preamble of a packet transmitted by another device. A device in a state or condition such that the device cannot communicate concurrently may analyze the preamble when the packet is sensed on the medium and decide whether or not to transmit based on a set of rules.

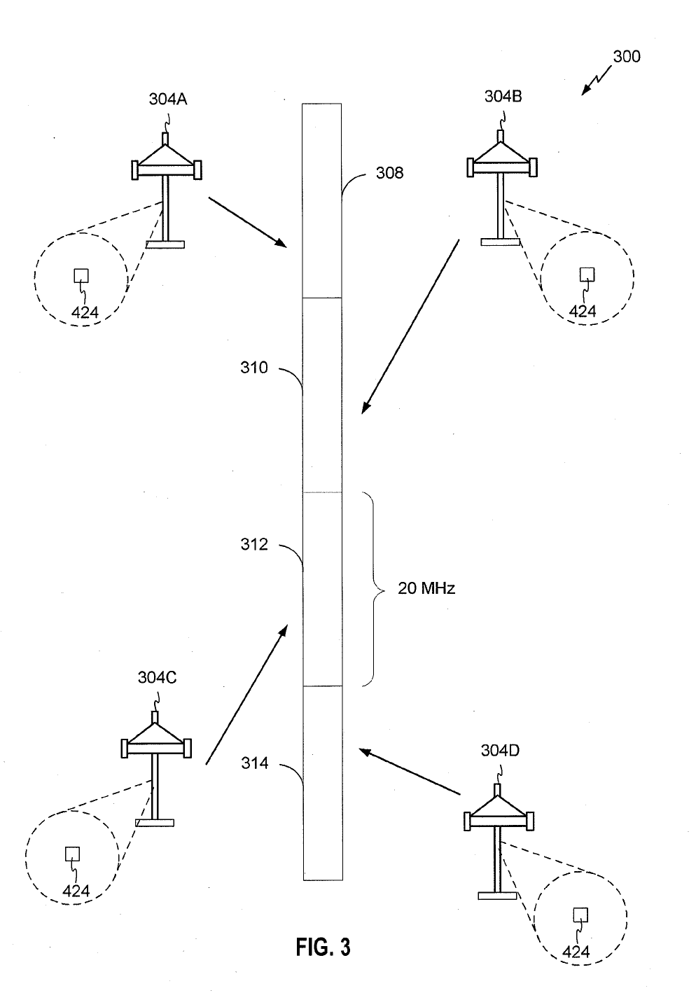

In another embodiment, devices that are in a state or condition such that they cannot communicate concurrently use frequency domain multiplexing techniques to communicate over the medium. FIG. 3 shows frequency multiplexing techniques that may be employed within the wireless communication systems 100 of FIGS. 1 and 250 of FIG. 2B. As illustrated in FIG. 3, an AP 304A, 304B, 304C, and 304D may be present within a wireless communication system 300. Each of the APs 304A, 304B, 304C, and 304D may be associated with a different BSA and include the high-efficiency wireless component 424, as described in more detail in connection with FIG. 4 below.

As an example, the bandwidth of the communication medium may be 80 MHz. Under the regular 802.11 protocol, each of the APs 304A, 304B, 304C, and 304D and the STAs associated with each respective AP attempt to communicate using the entire bandwidth, which can reduce throughput. However, under the high-efficiency 802.11 protocol using frequency domain multiplexing, the bandwidth may be divided into four 20 MHz segments 308, 310, 312, and 314 (e.g., channels), as illustrated in FIG. 3. The AP 304A may be associated with segment 308, the AP 304B may be associated with segment 310, the AP 304C may be associated with segment 312, and the AP 304D may be associated with segment 314.

In an embodiment, when the APs 304A-D and the STAs that are in a state or condition such that the STAs can communicate concurrently with other devices (e.g., STAs near the center of the BSA) are communicating with each other, then each AP 304A-D and each of these STAs may communicate using a portion of or the entire 80 MHz medium. However, when the APs 304A-D and the STAs that are in a state or condition such that the STAs cannot communicate concurrently with other devices (e.g., STAs near the edge of the BSA) are communicating with each other, then AP 304A and its STAs communicate using 20 MHz segment 308, AP 304B and its STAs communicate using 20 MHz segment 310, AP 304C and its STAs communicate using 20 MHz segment 312, and AP 304D and its STAs communicate using 20 MHz segment 314. Because the segments 308, 310, 312, and 314 are different portions of the communication medium, a first transmission using a first segment would not interference with a second transmission using a second segment.

Thus, APs and/or STAs, even those that are in a state or condition such that they cannot communicate concurrently with other devices that include the high-efficiency wireless component 424 can communicate concurrently with other APs and STAs without interference. Accordingly, the throughput of the wireless communication system 300 may be increased. In the case of apartment buildings or densely-populated public spaces, APs and/or STAs that use the high-efficiency wireless component may experience reduced latency and increased network throughput even as the number of active wireless devices increases, thereby improving user experience.

FIG. 4 shows an exemplary functional block diagram of a wireless device 402 that may be employed within the wireless communication systems 100, 250, and/or 300 of FIGS. 1, 2B, and 3. The wireless device 402 is an example of a device that may be configured to implement the various methods described herein. For example, the wireless device 402 may comprise the AP 104, one of the STAs 106, one of the APs 254, one of the STAs 256, and/or one of the APs 304.

The wireless device 402 may include a processor 404 which controls operation of the wireless device 402. The processor 404 may also be referred to as a central processing unit (CPU). Memory 406, which may include both read-only memory (ROM) and random access memory (RAM), may provide instructions and data to the processor 404. A portion of the memory 406 may also include non-volatile random access memory (NVRAM). The processor 404 typically performs logical and arithmetic operations based on program instructions stored within the memory 406. The instructions in the memory 406 may be executable to implement the methods described herein.

The processor 404 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 402 may also include a housing 408 that may include a transmitter 410 and/or a receiver 412 to allow transmission and reception of data between the wireless device 402 and a remote location. The transmitter 410 and receiver 412 may be combined into a transceiver 414. An antenna 416 may be attached to the housing 408 and electrically coupled to the transceiver 414. The wireless device 402 may also include (not shown) multiple transmitters, multiple receivers, multiple transceivers, and/or multiple antennas.

The wireless device 402 may also include a signal detector 418 that may be used in an effort to detect and quantify the level of signals received by the transceiver 414. The signal detector 418 may detect such signals as total energy, energy per subcarrier per symbol, power spectral density and other signals. The wireless device 402 may also include a digital signal processor (DSP) 420 for use in processing signals. The DSP 420 may be configured to generate a packet for transmission. In some aspects, the packet may comprise a physical layer data unit (PPDU).

The wireless device 402 may further comprise a user interface 422 in some aspects. The user interface 422 may comprise a keypad, a microphone, a speaker, and/or a display. The user interface 422 may include any element or component that conveys information to a user of the wireless device 402 and/or receives input from the user.

The wireless devices 402 may further comprise a high-efficiency wireless component 424 in some aspects. The high-efficiency wireless component 424 may include a classifier unit 428 and a controller 430. As described herein, the high-efficiency wireless component 424 may enable APs and/or STAs to use a modified mechanism that minimizes the inefficiencies of the CSMA mechanism (e.g., enables concurrent communications over the medium in situations in which interference would not occur).

The modified mechanism may be implemented by the classifier unit 428 and the controller 430. In an embodiment, the classifier unit 428 determines which devices are in a state or condition such that they can communicate concurrently with other devices and which devices are in a state or condition such that they cannot communicate concurrently with other devices. In an embodiment, the controller 430 controls the behavior of devices. For example, the controller 430 may allow certain devices to transmit concurrently on the same medium and allow other devices to transmit using a spatial multiplexing or frequency domain multiplexing technique. The controller 430 may control the behavior of devices based on the determinations made by the classifier unit 428.

The various components of the wireless device 402 may be coupled together by a bus system 426. The bus system 426 may include a data bus, for example, as well as a power bus, a control signal bus, and a status signal bus in addition to the data bus. Those of skill in the art will appreciate the components of the wireless device 402 may be coupled together or accept or provide inputs to each other using some other mechanism.

Although a number of separate components are illustrated in FIG. 4, those of skill in the art will recognize that one or more of the components may be combined or commonly implemented. For example, the processor 404 may be used to implement not only the functionality described above with respect to the processor 404, but also to implement the functionality described above with respect to the signal detector 418 and/or the DSP 420. Further, each of the components illustrated in FIG. 4 may be implemented using a plurality of separate elements.

In some implementations, resources and operational modes of APs/STAs in networks with dense deployments of multiple BSSs are coordinated to reduce interference. In some aspects, one or more dimensions including time, frequency, space, and power are coordinated between APs/STAs. In some aspects, coordination messages are sent between APs/STAs. In some aspects, specific enhancements to 802.11ah scheduling and 802.11aa coordination protocol are employed.

FIG. 5 shows examples of coordinated transmissions that may be employed within the wireless communication systems 100 of FIGS. 1 and 250 of FIG. 2B. FIG. 5 illustrates three access points 504A-C. Each access point 504A-C manages a corresponding BSS 502A-C. Each access point 504A-C is in communication with a plurality of stations 506. For example, access point 504A is in communication with stations 506A-C, while access point 504C is in communication with stations 506G-H. Each of the STAs 506A-H as well as the APs 504A-C may include a high efficiency wireless component 424 as previously described in connection with FIG. 4. FIG. 5 may represent an example of a densely populated wireless communication network.

In some aspects, the physical location of a station relative to other stations, its associated access point, and/or other access points may make the station more or less subject to interference. For example, because stations 506D-E are positioned relatively close to their access point 504B and relatively far from other BSS's 502A and 502C, and access points and stations communicating within those BSS's, stations 506D-E may be less susceptible to interference when either of those BSS's communicate. Similarly, STA 506H may be less susceptible to interference from transmissions generated by either BSS 502A or 502B. Because these devices may not be susceptible to interference, some of the devices may communicate concurrently with other devices, even if a traditional carrier sense media access mechanism would prevent such concurrent transmission. For example, STA 506H may communicate with access point 504C concurrently with access point 504B communicating with stations 506D or 506E.

Other stations may be more susceptible to interference, for example, stations positioned relatively further from their access points and/or relatively closer to wireless devices of other BSSs may be more susceptible to interference.

The wireless device 402 illustrated in FIG. 4 may comprise an AP 104, a STA 106, an AP 254, a STA 256, and/or an AP 304, and may be used to transmit and/or receive communications. That is, either AP 104, STA 106, AP 254, STA 256, or AP 304 may serve as transmitter or receiver devices. Certain aspects contemplate signal detector 418 being used by software running on memory 406 and processor 404 to detect the presence of a transmitter or receiver.

In a dense BSS scenario as illustrated in FIG. 5, significant throughput gains can be achieved if BSSs coordinate their access to the airwaves or medium in one or more of time, frequency, space, and power. In some implementations, APs 504A, 504B, and 504C coordinate the use of resources and operational modes of the shared medium to reduce the likelihood that wireless devices 402 are subject to interference. A wireless device 402 can be subject to interference by either causing interference with another wireless device 402 or experiencing interference caused by another wireless device 402.

In other implementations, one of the APs 504A, 504B, and 504C receives instructions from another one of the APs 504A, 504B, and 504C to modify its use of one of the wireless devices 402 associated with the receiving AP's use of the airwaves or medium to reduce the likelihood that a wireless device 402 is subject to interference. In certain embodiments, the APs 504A, 504B, and 504C exchange information to coordinate their use of the shared medium. In other embodiments the AP 504A, 504B, and 504C receives an instruction from another AP 504A, 504B, and 504C on how it should use the shared medium.

For example, the APs 504A, 504B, and 504C can coordinate access to the shared medium even when the APs are associated with different BSS 502A, 502B, and 502C. The APs 504A, 504B, and 504C can determine whether one or more wireless devices 402 is subject to interference with another wireless device in the wireless network. The APs 504A, 504B, and 504C identify the one or more wireless devices 402 that are subject to interference via identifying information such as a MAC address. The APs 504A, 504B, and 504C then receive information from each other on the nature of the interference and/or the shared medium. The APs 504A, 504B, and 504C then modify the use of the shared medium by one or more of the wireless devices 402 to reduce the likelihood that the wireless device is subject to interference. In some implementations, this modification includes transmission of one or more messages 508A, 508B, and 508C between APs as illustrated in FIG. 5.

In other embodiments, the AP 504A, 504B, and 504C receives an instruction from another AP 504A, 504B, and 504C on how it should use the shared medium. For example, the AP 504A, 504B, and 504C can receive information associated with the first or second BSSs. The information can include an identification of one or more wireless devices that are subject to interference. The receiving AP 504A, 504B, and 504C then modifies, based on the received information, the use of the shared medium to reduce the likelihood that the one or more wireless devices are subject to interference. The modification can be to resources including, but not limited to, time, frequency, and space. The modification can be to operation modes including, but not limited to, transmission parameters and access modes.

Time

In some implementations where the modification or coordination relates to time, orthogonal activity periods are scheduled across APs 504A, 504B, and 504C. In some implementations, scheduling of orthogonal activity periods across APs 504A, 504B, and 504C is only for transmission to a certain subset of wireless devices 402 or users. Other users can be served at any time. An exemplary subset is “edge users” or wireless devices 402 that may suffer interference from neighboring APs 504A, 504B, and 504C. In some implementations, DL/UL transmissions are aligned across APs 504A, 504B, and 504C. Additional implementations are described below.

Frequency

In some implementations where the modification or coordination relates to frequency, orthogonal channels are scheduled for transmission use across BSS 502A, 502B, and 502C. For example, a primary channel location is scheduled across APs 504A, 504B, and 504C. In some implementations, orthogonal channels are scheduled across APs 504A, 504B, and 504C for only a subset of wireless devices 402 or STAs. Other wireless devices or STAs 402 can be served on any channel. In some implementations, channels used for DL/UL transmissions are aligned across APs 504A, 504B, and 504C. Additional implementations are described below.

Space

In some implementations where the modification or coordination relates to spatial domains, orthogonal “beams” are scheduled across BSS 502A, 502B, and 502C. In some implementations, beams are aligned across APs 504A, 504B, and 504C. Additional implementations are described below.

Power

In some implementations where the modification or coordination relates to power, coordination is achieved by selecting transmission power for DL and UL transmissions across APs 504A, 504B, and 504C. Additional implementations are described below.

Coordination of Resources

Coordination across APs 504A, 504B, and 504C can be achieved as explicit communications across APs 504A, 504B, and 504C/STAs 506A-H of different BSS 502A, 502B, and 502C and/or implicit communications/measurements based on observation of the traffic on the medium. For example, explicit messages can be sent over the air 508A-C or over a separate communication means such as a cable backhaul. In some implementations, messages are exchanged directly between APs 504A, 504B, and 504C, between APs 504A, 504B, and 504C via STAs 506A-H, directly between STAs 506A-H, and/or between STAs 506A-H via APs 504A, 504B, and 504C. In some implementations which use implicit communications, packets are enhanced to carry partial information that can help the coordination. In some implementations, coordination of final decisions are made by a central informed controller, with a distributed heuristic at each AP, and/or based on exchanged information at each STA.

In some implementations of the coordination protocol, APs 504A, 504B, and 504C/STAs 506A-H exchange information on resources including time/frequency/space/power. In some implementations, APs 504A, 504B, and 504C/STAs 506A-H exchange information on operation modes including transmission parameters and access modes. The exchanged information can include positive or negative requests. For example, a positive request can be for the sender AP 504A, 504B, and 504C to use a requested resources/operation modes. A negative request can be for the receiving AP 504A, 504B, and 504C to not use the indicated resources/operation modes.

Time

In some implementations where time is coordinated across APs 504A, 504B, and 504C, messages exchanged across APs 504A, 504B, and 504C/STAs 506A-H include positive/negative requests for one or more of start time, duration, periodicity of access time to which the positive/negative request is referred to, and/or types of allowed access. For example, types of access can include enhanced distributed channel access (EDCA)/backoff/schedule parameters such as an arbitration inter frame spacing (AIFS), contention window min or max (CWmin, CWmax), TXOP limit, and CCA thresholds. In some implementations, the type of access is traffic QoS such as admission control (AC), max amount of transmission time and/or bytes allowed.

In some implementations, the coordination protocol includes a mechanism that allows APs 504A, 504B, and 504C/STAs 506A-H to reach an agreement on time usage so that transmissions of neighboring APs 504A, 504B, and 504C/STAs 506A-H are disjoint in time and/or transmissions to/from a certain set of STAs 506A-H. For example, STAs 506 that are indicated as interfering in the messaging are allocated non overlapping RAWs/TWTs across neighboring APs 504A, 504B, and 504C. In certain implementations, the interfering wireless device may be an APs 504A, 504B, and 504C. For example, STAs 506A-H that are ‘likely to be interfered’ or have a weak link or have limitations on the BW such as edge STA 506A, 506F, 506G are allocated disjoint time resources. In some implementations UL transmissions (from STAs only) are allowed or DL transmission (from AP) are allowed, or both in an overlapping restricted access window (RAW) timing and/or target wakeup time (TWT) timing. In some implementations, it is preferred that transmissions to/from STAs with same or similar access modes (QoS/EDCA parameters) happen at the same time while transmissions to/from STAs with different access modes (QoS/EDCA parameters) happen at different times.

STAs/APs Coordination

In some implementations, APs 504A, 504B, and 504C/STAs 506A-H exchange requests/responses for use of resources and operation modes by specific STAs 506A-H/APs 504A, 504B, and 504C. Messages exchanged across APs 504A, 504B, and 504C/STAs 506A-H can include positive/negative requests for one or more specific STAs 506A-H/APs 504A, 504B, and 504C. For example, the specific STAs 506A-H/APs 504A, 504B, and 504C can be a number/group of STAs that belong to the AP sending the message. The sending AP would like to be active in terms of address, location, and/or a transmission characteristic such as power, rate, and interference condition.

In some implementations, the specific STAs 506A-H/APs 504A, 504B, and 504C is a group of STAs that include STAs belonging to the neighboring AP that will receive the message. The specific STAs 506 may be identified in terms of address, location, and/or transmission characteristic such as power, rate, and interference condition. In some implementations, the information identifies STAs 506 that interfere with the sending AP operation, or with operation of STAs associated with the sending AP.

In some implementations, the specific STAs 506A-H/APs 504A, 504B, and 504C is a group of STAs that indicate operation capability of STAs such as type of protocols supported (802.11a/n/ac/b), TX/RX parameters supported, and/or type of operation/traffic supported.

In some implementations, the coordination protocol includes a mechanism that allows APs 504A, 504B, and 504C/STAs 506A-H to reach an agreement on which STAs are allowed access to prevent interfering STAs from using the same resource and/or to schedule the same resources for STAs that have similar transmission characteristics. For example, in some implementations, edge STAs 506A, 506F, and 506G are scheduled at the same time while center STAs 506 B-E, H are scheduled at the same time. In some implementations, only STAs with compatible operation modes are sharing resources.

Frequency

In some implementations, APs 504A, 504B, and 504C/STAs 506A-H exchange requests/responses for use of resources and operation modes in certain frequency bands/channels. Messages exchanged across APs 504A, 504B, and 504C/STAs 506A-H can include positive/negative requests for one or more of a primary channel, channel(s) used for transmission, allowed transmission BW, allowed mode on transmission such as direction UL/DL and PHY mode, allowed STAs 506A-H/APs 504A, 504B, and 504C for transmission in each channel such as inner/outer STAs and interfering STAs that are allowed/not allowed to transmit.

In certain implementations, the coordination protocol includes a mechanism that allows APs 504A, 504B, and 504C/STAs 506A-H to reach an agreement on which STAs are allowed to access such that disjoint primary channels are allocated to interfering APs 504A, 504B, and 504C/STAs 506A-H. Allowed transmission BW can be optimized for reuse by, for example, limiting transmission BW such that independent resources are available for APs 504A, 504B, and 504C. In some implementations, different channels/BW are used for STAs in different locations/transmit conditions. For example, center STAs 506 B-E, H can be allowed to use all the BW while edge STAs 506A, 506F, and 506G use a channel that is different from the channel used by edge STAs 506A, 506F, and 506G in neighboring APs 504A, 504B, and 504C. In this way, scheduling communications between the STAs 506A-H based on frequency bandwidths per STA class as described above may enable communication in densely populated wireless communications networks.

Spatial Coordination

In some implementations, APs 504A, 504B, and 504C/STAs may exchange requests/responses for use of resources and operation modes in certain spatial domains. Messages exchanged across APs 504A, 504B, and 504C/STAs 506A-H can include positive/negative requests for one or more of a location of the STA/APs 504A, 504B, and 504C that can use the shared medium including direction UL/DL. In some implementations, the requests relate to identification of the spatial domain such as absolute/relative geographical description/positioning or interfering relations between STAs/APs 504A, 504B, and 504C. In other implementations, the requests include an indication of whether beam forming is allowed or which spatial sectors or spatial beams are to be used. In some implementations, interfering relations between STAs/APs 504A, 504B, and 504C can be based on strength of interference and/or exact channel representation.

In some implementations, the communication protocol includes a mechanism that allows APs 504A, 504B, and 504C/STAs to reach an agreement such that non interfering spatial domains are used across BSS 502A, 502B, and 502C by, for example, employing orthogonal sectors, beams, and STAs locations. In some implementations, simultaneous transmissions are TX/RX filtered based on channel state information received by all involved STAs so that cross interference is minimized. In this way, scheduling communications between the STAs 506A-H based on spatial considerations and beam forming as described above may enable communication in densely populated wireless communications networks.

Transmission of Coordination Messages

In some implementations, coordination messages are sent by APs 504A, 504B, and 504C/STAs 506A-H on a common control channel. The common control channel can be a commonly identified frequency channel that is common among the operating BWs of the neighboring APs 504A, 504B, and 504C/STAs 506A-H. For example, the channel may be one of the 20 Mhz channels out of the 80/160/320 data operation band or in a band that is disjoint from the data operation band such as when data is exchanged in 2.4 GHz and control is exchanged in 900 MHz. An advantage of using 900 MHz is the transmission has a greater range than 2.4 GHz to reach distant APs 504A, 504B, and 504C. In some implementations, the common control channel is statically identified by the standard specifications. For example, a default 20 MHz channel for each allowed operating 20/40/80/160 BSS 502A, 502B, AND 502C operating channel is used in some implementations. In some implementations, channels are agreed across neighboring APs 504A, 504B, and 504C via a distributed election protocol. In some implementations, the coordination messages are sent at a common time agreed across neighboring APs 504A, 504B, and 504C/STAs 506A-H.

In some implementations, coordination messages are sent by APs 504A, 504B, and 504C and relayed by STAs 506A-H to reach neighboring APs 504A, 504B, and 504C. For example, the coordination messages can be carried by STA-STA or STA-AP communications across STAs 506A-H/APs 504A, 504B, and 504C that are not associated with each other. In some implementations, Generic Advertisement Service (GAS) frames or other frames are exchanged without an association in place to send coordination messages. In other implementations, coordination messages are carried by STA-STA or STA-AP communications across STAs/APs 504A, 504B, and 504C associated with each other using, for example, a new form of STA-STA or STA-AP association across BSS 502A, 502B, and 502C.

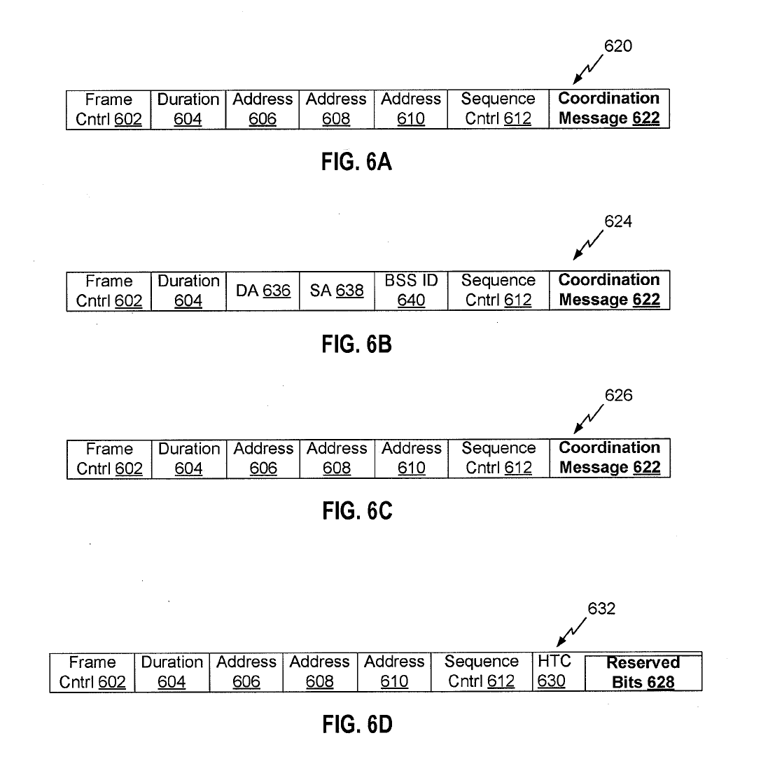

In some implementations, the coordination messages 622 used to exchange information are sent in new frames defined by the IEEE standard such as management frames 520 (see FIG. 6A), action frames 524 (see FIG. 6B), and/or GAS frames 526 (see FIG. 6C). The coordination messages 622 can include HEW parameters that can be exchanged across APs 504A, 504B, and 504C. In some implementations, only certain of the existing indications of the new frames 620, 624, 626 are employed. In some implementations additional indications, such as the HEW parameters within the coordination messages 622, are added to the existing indications already defined by the new frames.

FIG. 6A is a representation of a management frame 620 that may be employed within the wireless communication systems disclosed herein. The management frame 622 may comprise several fields common to management frames, for example, one or more of a frame control field 602, a duration field 604, a first address field 606, a second address field 608, a third address field 610, and a sequence control field 612. The management frame 620 may additionally include the coordination message 622 including HEW parameters as previously described. Although exemplary fields are shown, the management frame 620 may include less than all of the above-described fields and/or may further include one or more additional fields not shown.

FIG. 6B is a representation of an action frame 624 that may be employed within the wireless communication systems disclosed herein. The action frame 624 may comprise several fields common to action frames, for example, one or more of the frame control field 602, the duration field 604, a destination address field 636, a source address field 638, a BSS ID field 640, and the sequence control field 612. The action frame 624 may additionally include the coordination message 622 including HEW parameters as previously described. Although exemplary fields are shown, the action frame 624 may include less than all of the above-described fields and/or may further include one or more additional fields not shown.

FIG. 6C is a representation of a GAS frame 626 that may be employed within the wireless communication systems disclosed herein. The GAS frame 626 may comprise several fields common to GAS frames, for example, one or more of the frame control field 602, the duration field 604, the first address field 606, the second address field 608, the third address field 610, and the sequence control field 612. The GAS frame 626 may additionally include the coordination message 622 including HEW parameters as previously described. Although exemplary fields are shown, the GAS frame 626 may include less than all of the above-described fields and/or may further include one or more additional fields not shown.

FIG. 6D is a representation of a frame 632 including an HTC control field 630 that includes a reserve bit 628 that may be employed within the wireless communication systems disclosed herein. The frame 632 may comprise several fields, for example, one or more of the frame control field 602, the duration field 604, the first address field 606, the second address field 608, the third address field 610, and the sequence control field 612. In some implementations, the coordination messages 622, including HEW parameters as previously described, are embedded in existing frames by using reserved bits 628. For example, reserved bits 628 can be used to override the HTC control field 630 in HT or VHT format as is illustrated in FIG. 6D. In some implementations, parameters related to usage of resources are implicitly derived by measuring activity on the resource of interest. Although exemplary fields are shown, the frame 632 may include less than all of the above-described fields and/or may further include one or more additional fields not shown.

Time Coordination

In some implementations where time is coordinated between APs 504A, 504B, and 504C, existing communication protocols are used. For example, 802.11ah defines protocols (alternative to HCCA) for time schedule within BSS 502A, 502B, and 502C with no coordination using restricted access window (RAW) and target wake time (TWT). RAW is an interval of time advertised by the AP in a beacon which is reserved for access to only a certain group of STAs. In a modification, the group is empty which prevents all STAs from transmitting at a certain time. TWT is an agreement between AP and an STA for a time when the STA is to be awake and engage in communication with the AP. In a modification, the STAs cannot transmit outside the agreed time.

In certain embodiments, the coordination protocol allows the exchange of RAW and TWT parameters across APs 504A, 504B, and 504C so that RAW/TWT parameter settings can be coordinated across APs 504A, 504B, and 504C. For example, the set of parameters that define a RAW are listed in the RAW parameter set (RPS) Information element defined by 802.11ah.

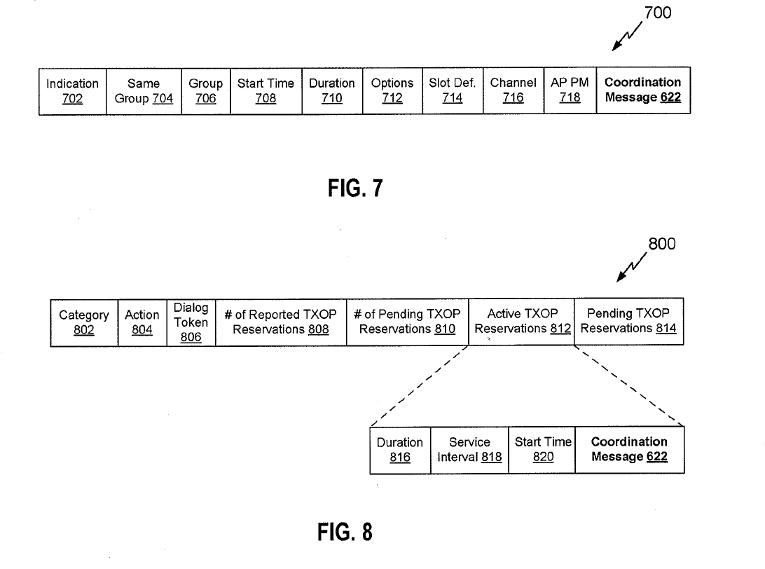

FIG. 7 is a representation of a modified RPS information element 700 defined by 802.11ah that may be employed within the wireless communication systems disclosed herein. The modified RPS information element 700 The RPS IE 700 may comprise, for example, one or more of a PRAW indication field, a same group indication field 704, a group indication field 706, a start time field 708, a duration field 710, an options field 712, a slot definition field 714, a channel field 716, an access point PM field 718 and the coordination message 622, including HEW parameters as previously described, disposed within the RPS IE 700. Although exemplary fields are shown, the RPS IE 700 may include less than all of the above-described fields and/or may further include one or more additional fields not shown. Within the coordination protocol, APs 504A, 504B, and 504C can exchange one or more of the above indications including the HEW parameters within the coordination message 622 per each potential RAW or TWT or equivalent reservation protocol. The provided parameters may refer to a (positive) request for the sender AP 504A, 504B, and 504C to use the requested resources/operation modes or a (negative) request for the receiving AP 504A, 504B, and 504C not to use the indicated time/operation.

In some implementations, one or more of the above indications is included in the same or similar message as the Transmit Opportunity (TXOP) Advertisement frame used in 802.11aa. 802.11aa defines a protocol for AP 504A, 504B, and 504C to AP 504A, 504B, and 504C coordination where APs 504A, 504B, and 504C can decode each other's beacons. Protocol messaging is included in the beacon or exchanged though action frames. Messaging can be encrypted with a key known by APs 504A, 504B, and 504C. In some implementations, the messages include time synchronization (TSF) and/or requests for the use of an interval of time for medium access (TXOP) that is always available to the AP. The coordination protocol allows agreement on the TXOP allocation across APs 504A, 504B, and 504C. Under 802.11aa, APs 504A, 504B, and 504C exchange information to manage their STAs medium access by using a medium access procedure such as HCF Controlled Channel Access (HCCA). Under HCCA STAs are not allowed to access the medium unless they are polled by the AP 504A, 504B, and 504C. In this way the AP 504A, 504B, and 504C is in full control of medium usage. However, 802.11aa is limited in that it only uses AP-AP direct communications, only allows for time allocation of TXOP, and only refers to the use of HCCA as medium access techniques.

In some implementations, APs 504A, 504B, and 504C use action frames defined by 802.11aa to share request/responses about TXOP allocation.

FIG. 8 is a representation of a modified advertisement action frame 800 action field and of a TXOP reservation field format defined by 802.11aa that includes the coordination message 622 having the HEW parameters. In some implementations, additional information, such as HEW parameters within the coordination message 622, is transported via the protocol defined by 802.11aa by means of modified or new frame formats. In some implementations, additional protocol rules are also defined as set forth above. For example, the action frame 800 may comprise one or more of a category field 802, an action field 804, a dialog token field 806, a number of reported TXOP reservations field 808, a number of pending TXOP reservations field 810, an active TXOP reservations field 812 and a pending TXOP reservations field 814. Although exemplary fields are shown, the action frame 800 may include less than all of the above-described fields and/or may further include one or more additional fields not shown. Within the active TXOP reservations field 812, several subfields may be present. For example, the active TXOP reservations field 812 may comprise one or more of a duration field 816, a service interval field 818, a start time field 820, and the coordination message 622 having the HEW parameters as previously described. Although exemplary subfields are shown, the active TXOP reservations field 812 may include less than all of the above-described subfields and/or may further include one or more additional subfields not shown.

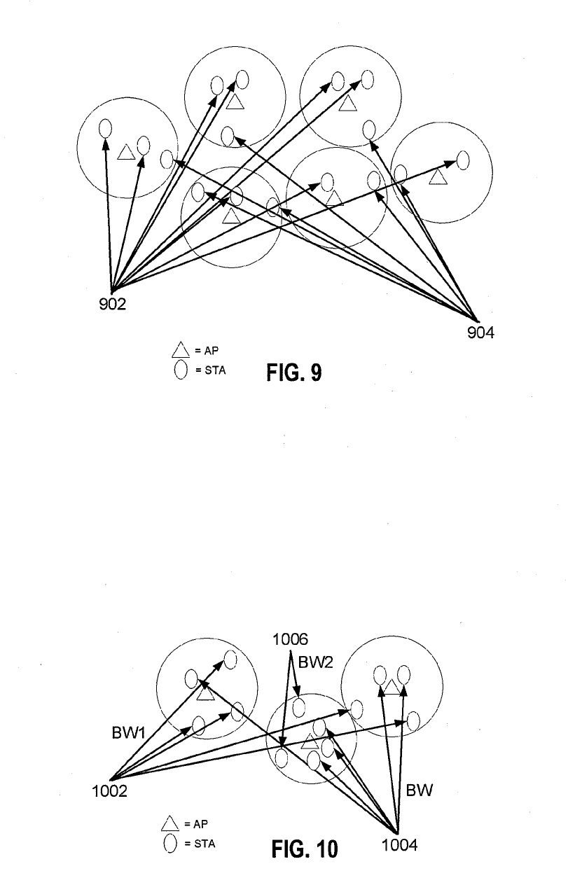

In some implementations, certain STAs from different BSS are allowed to transmit at the same time even in cases where the current WiFi CSMA procedure would not allow transmission. FIG. 9 is an exemplary wireless communication system employing time coordination for STA communication. FIG. 9 may represent another example of a densely populated wireless communication network. For example, ‘cell center’ STAs 902 in FIG. 9 are allowed to transmit at the same time. However, certain STAs from the different BSSs are prevented from transmitting at the same time even in cases where the current WiFi CSMA procedure would allow transmission. For example, ‘cell edge’ STAs 904 in FIG. 9 are prevented from transmitting even if allowed by the current WiFi CSMA procedure. As previously stated in connection with FIGS. 2A and 2B, the “cell center” STAs comprise STAs that are relatively close to their associated AP, while the “cell edge” STAs comprise STAs that are relatively far from their associated AP (e.g, near the edge of their associated BSA).

Referring to FIGS. 5 and 9, in some implementations, coordination requires identification of the STAs/APs that interfere with each other such as ‘cell center’ STAs 506B-E, H, 902 and ‘cell edge’ STAs 506A,F,G, 904, communication across APs/STAs of different BSSs to agree on the time schedule for communication, and/or the use of a scheduling protocol that determines the schedule.

In some implementations, interfered STAs such as ‘cell center’ STAs 506B-E,H, 902 and ‘cell edge’ STAs 506A,F,G, 904 are reported by STAs to the AP. The interfered STA can be identified by its MAC address or a Partial AID (PAID) address. In some implementation, STAs report interfered STAs belonging to neighboring BSSs. In some implementations where the MAC address is not available because, for example, the address is sent at a high rate, a Partial AID may be used. However, a Partial AID may not be unique to the STA. To increases the uniqueness of the Partial AID, the neighboring APs 504A, 504B, and 504C can use disjoint PAID spaces. Access points may exchange signaling to coordinate the selection of disjoint Partial AID spaces. In some implementations, the reporting STA includes additional interference information such as signal strength and frequency of interference. In some implementations, 802.11k messaging or similar is used.

In some implementations, STAs request to be considered in one of at least two classes such as interfered or non-interfered. The request can be based on the level of interference experienced from BSS AP/STA packets even without precise identification of the interference source.

In some implementations, interfered STAs such as ‘cell center’ STAs 506B-E,H, 902 and ‘cell edge’ STAs 506A,F,G, 904 are classified by the AP based on throughput/Packet error rate or by messages sent by STAs over the air and collected by the AP. In some implementations, the messages are sent in management frames with contention or at scheduled times.

Referring back to FIG. 5, a time schedule can be agreed across APs 504A, 504B, and 504C/STAs of different BSS 502A, 502B, and 502C. In some implementations, a modified 802.11 as framework is used. For example, the messages being sent across APs 504A, 504B, and 504C may include requested interval of time, a list of STAs that should be silenced during the requested time or that should adopt certain medium access procedure (may include AP), and/or the specific settings for the access procedure, such as QoS/enhanced distributed channel access (EDCA) parameters that should be used during that time, allowed Access Category, clear channel assessment parameters (CCA and energy detection threshold), maximum transmission duration, maximum amount of traffic that can be delivered, allowed power of transmission and other transmit operation modes parameters.

In some implementations where time coordination across APs 504A, 504B, and 504C is based on received information, the protocol schedules reserves time or adapts the behavior of the interfering STA. For example, if reserved time is granted based on communication across APs 504A, 504B, and 504C, the requesting AP/STAs uses the reserved time for transmission to the AP/STAs that would otherwise have experienced interference. During this time the requesting AP/STAs may access the medium with favorable access procedures. Favorable access procedures include the use of a less sensitive clear channel assessment or no clear channel assessment at all, the use of EDCA parameter settings that result in higher priority access to the medium, the use of a longer transmission, higher maximum amount of traffic delivered, higher power of transmission, and/or other favorable transmit operation modes. During this time the requesting AP/STAs may also not defer medium access upon detection of packets on the medium, as it would be requested by 802.11 medium access procedures. AP/STAs may instead drop certain detected packets and ignore them, considering the medium available for transmission. The certain packets may be identified by a Partial AID, a MAC address, and/or an explicit indication embedded in the PHY preamble.

In some implementations, interfering STAs are forbidden from accessing during the reserved time or their access is subject to less favorable procedures. Less favorable access procedures include the use of a more sensitive clear channel assessment, the use of EDCA parameter settings that result in lower priority access to the medium, the use of shorter transmission, lower maximum amount of traffic delivered, lower power of transmission and/or other less favorable transmit operation modes. During this time interfering AP/STAs may also defer medium access upon detection of certain packets on the medium. The certain packets may be all the detected packets or may be identified by a Partial AID, a MAC, address (e/g referred to an interfered STA), and/or an explicit indication embedded in the PHY preamble indicating that deferral must happen.

In some implementations, if the behavior of the interfering STA is adapted to protect interfered STAs without strict time boundaries, the interfering STAs must use a more sensitive deferral to frames sent by/to interfered STAs. For frames sent by/to other STAs deferral may be weaker. In some implementations, frames sent by/to interfered STAs can be identified via Partial AID in the PHY header, a MAC address, and/or specific bits in the PHY preamble. Sensitive deferral may refer to CCA levels, EDCA parameters, duration of transmissions, and/or use of RTS/CTS. In some implementation, interfered STAs are allowed to use techniques that favor their access by indicating with one bit in the PHY header that their transmission is protected, using favorable EDCA parameters, and/or using RTS/CTS. In this way, scheduling communications between the STAs 506A-H based on non-conflicting communication timing as described above may enable communication in densely populated wireless communications networks.

Frequency Coordination

FIG. 10 is an exemplary wireless communication system employing frequency coordination for STA communication. FIG. 10 may represent another example of a densely populated wireless communication network. In some implementations, “cell center” STAs 1004 use the whole bandwidth (BW). “Cell edge” STAs 1002 may only be served with a first frequency bandwidth (e.g., BW1) while “cell edge” STAs 1006 may only be served with a second frequency bandwidth (e.g., BW2). Of course other arrangements are within the scope of the disclosure that reduces the likelihood of interference.

In some implementations, coordination requires identification of the STAs/APs that interfere with each other such as cell edge STAs 1002, 1006. In some implementations, coordination requires communication across APs/STAs of different BSS to agree on the channels schedule. In some implementations, coordination requires the use of a scheduling protocol that determines the channel schedule.

In some implementations, interfered STAs such as ‘cell center’ STAs and ‘cell edge’ STAs are reported by STAs to the AP. The interfered STA can be identified by its MAC address or a Partial AID address. In some implementation, the STA reports interfered STAs belonging to neighboring BSS and includes a channel indication. In some implementations where the MAC address is not available because, for example, the address is sent at high rate, a Partial AID may be used. However, a Partial AID may not be unique to the STA. To increases the uniqueness of the Partial AID, the neighboring APs can use disjoint PAID spaces. In some implementations, the reporting STA includes additional interference information such as signal strength and frequency of interference. In some implementations, 802.11k messaging or similar is used.

In some implementations, STAs request to be considered in one of at least two classes such as interfered or non-interfered. The request can be based on the level of interference experienced from BSS AP/STA packets even without precise identification of the interference source.

In some implementations, interfered STAs such as ‘cell center’ STAs and ‘cell edge’ STAs are classified by the AP based on throughput/Packet error rate/channel or by messages sent by STAs over the air and collected by the AP. In some implementations, the messages are sent in management frames with contention or at scheduled times.

Referring to FIG. 5, a frequency schedule can be agreed across APs 504A, 504B, AND 504C/STAs of different BSS 502A, 502B, and 502C. In some implementations, a modified 802.11aa framework is used. For example, the messages being sent across APs 504A, 504B, and 504C may include a requested frequency channel, a list of STAs that should be silenced on the requested channel or that should adopt certain medium access procedure (may include AP), and/or the specific settings for the access procedure, such as QoS/enhanced distributed channel access (EDCA) parameters that should be used on the requested channel, allowed Access Category, clear channel assessment parameters (CCA and energy detection threshold), maximum transmission duration, maximum amount of traffic that can be delivered, allowed power of transmission and other transmit operation modes parameters.

In some implementations where frequency coordination across APs 504A, 504B, and 504C is based on received information, the protocol schedules a reserved channel or adapts the behavior of the interfering STA. For example, if a reserved channel is granted based on communication across APs 504A, 504B, and 504C, the requesting AP/STAs uses the reserved channel for transmission to the AP/STAs that would otherwise have experienced interference. Interfering STAs are forbidden from accessing the reserved channel or their access is subject to transmission parameter limitations. For example, on the reserved channel the requesting AP/STAs may access the medium with favorable access procedures. Favorable access procedures include the use of a less sensitive clear channel assessment or no clear channel assessment at all, the use of EDCA parameter settings that result in higher priority access to the medium, the use of a longer transmission, higher maximum amount of traffic delivered, higher power of transmission, and/or other favorable transmit operation modes. On the reserved channel the requesting AP/STAs may also not defer medium access upon detection of packets on the medium, as it would be requested by 802.11 medium access procedures. AP/STAs may instead drop certain detected packets and ignore them, considering the medium available for transmission. The certain packets may be identified by a Partial AID, a MAC address, and/or an explicit indication embedded in the PHY preamble.

In some implementations, interfering STAs are forbidden from accessing the reserved channel or their access is subject to less favorable procedures. Less favorable access procedures include the use of a more sensitive clear channel assessment, the use of EDCA parameter settings that result in lower priority access to the medium, the use of shorter transmission, lower maximum amount of traffic delivered, lower power of transmission and/or other less favorable transmit operation modes. On the reserved channel interfering AP/STAs may also defer medium access upon detection of certain packets on the medium. The certain packets may be all the detected packets or may be identified by a Partial AID, a MAC address (e/g referred to an interfered STA), and/or an explicit indication embedded in the PHY preamble indicating that deferral must happen.

If the behavior of the interfering STA is adapted to protect interfered STAs without strict channel boundaries, the interfering STAs uses a lower transmission BW and/or a more sensitive deferral to frames sent by/to interfered STAs. For frames sent by/to other STAs the deferral may be weaker. In some implementations, frames sent by/to interfered STAs can be identified via Partial AID in the PHY header, a MAC address, and/or specific bits in the PHY preamble. Sensitive deferral may refer to CCA levels, EDCA parameters, duration of transmissions, and/or use of RTS/CTS. In some implementation, interfered STAs are allowed to use techniques that favor their access by indicating with one bit in the PHY header that their transmission is protected, using favorable EDCA parameters, and/or using RTS/CTS. In this way, scheduling communications between the STAs 506A-H based on frequency coordination per STA class as described above may enable communication in densely populated wireless communications networks. Please note that although described separately, coordination in time and frequency may happen simultaneously.

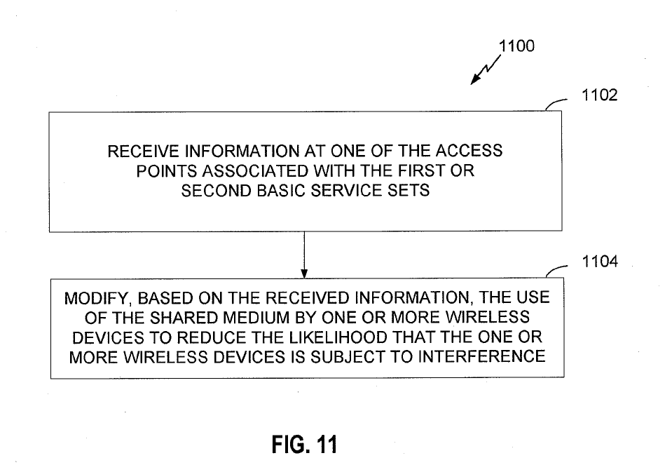

FIG. 11 is a flowchart 1100 of a method for coordinating access to a shared medium between an access point in a first basic service set and an access point in a second basic service set, each basic service set including one or more wireless devices. The method of flowchart 1100 is described herein with reference to FIGS. 1 through 4. In one implementation, one or more of the steps in flowchart 1100 may be performed by, or in connection with, a processor, memory, receiver, transmitter, classifier and/or controller such as the processor 404, the memory 406, the receiver 412, the transmitter 410, or the HEW component 424 including the classifier 428 and the controller 430 of FIG. 4, although those having ordinary skill in the art will appreciate that other components may be used to implement one or more of the steps described herein. Although blocks may be described as occurring in a certain order, the blocks can be reordered, blocks can be omitted, and/or additional blocks can be added.

The method may begin with block 1102, which includes receiving information at one of the APs associated with the first or second BSSs. For example, such information may be received at either the AP associated with the first BSS or the AP associated with the second BSS, as previously described in connection with FIGS. 2B, 3, 5, 6A-6D and 7-10.

The method may continue with block 1104, which includes modifying, based on the received information, the use of the shared medium by one or more wireless devices to reduce the likelihood that the one or more wireless devices is subject to interference. For example, such modifying may be carried out in any manner as previously described in connection with FIGS. 2B, 3-5, 6A-6D and 7-10. As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Further, a “channel width” as used herein may encompass or may also be referred to as a bandwidth in certain aspects.

As used herein, a phrase referring to “at least one of” a list of items refers to any combination of those items, including single members. As an example, “at least one of a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and Blu-ray® disc where disks usually reproduce data magnetically, while discs reproduce data optically with lasers. Thus, in some aspects, computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method for coordinating access to a shared medium between an access point (AP) in a first basic service set (BSS) and an access point (AP) in a second basic service set (BSS), each BSS including one or more wireless devices, comprising:
receiving information at one of the APs associated with the first or second BSSs; and
modifying, based on the received information, the use of the shared medium by one or more wireless devices to reduce the likelihood that the one or more wireless devices is subject to interference.

2. The method of claim 1 further comprising:
determining whether one or more wireless devices is subject to interference with another wireless device in the wireless network; and
identifying the one or more wireless devices that is subject to interference.

3. The method of claim 1, wherein the received information relates to one or more of a time, a frequency, a space, and a power for using the shared medium.

4. The method of claim 1, wherein modifying the use of the shared medium comprises explicit communication between the APs.

5. The method of claim 1, wherein modifying the use of the shared medium comprises implicit communication.

6. The method of claim 1, wherein modifying the use of the shared medium is performed at a central informed controller.

7. The method of claim 1, wherein modifying the use of the shared medium is performed at each of the APs.

8. The method of claim 1, wherein modifying the use of the shared medium is performed at each of the one or more wireless devices.

9. The method of claim 1, wherein the received information relates to at least one of transmission parameters and access modes.

10. The method of claim 1, wherein modifying the use of the shared medium comprises sending a request by the AP to use the shared medium.

11. The method of claim 1, wherein modifying the use of the shared medium comprises sending a message related to one or more of a start time for transmission, a duration for transmission, a periodicity of access time, a type of access, and a location of the identified one or more wireless devices.

12. The method of claim 1, wherein modifying the use of the shared medium comprises reaching an agreement on spatial usage.

13. The method of claim 1, wherein modifying the use of the shared medium comprises sending a message on a common control channel.

14. The method of claim 1, wherein the received information comprises one or more of a MAC address of the identified one or more wireless devices, and a request by the identified one or more wireless devices to be classified as non-interfered.

15. The method of claim 1, wherein the received information relates to one or more of a signal strength of the identified one or more wireless devices and a frequency of interference for the identified one or more wireless devices.

16. The method of claim 1, wherein the received information includes a classification of the identified one or more wireless devices determined by the AP.

17. The method of claim 1, wherein the received information includes a classification of the identified one or more wireless devices determined by the AP, and wherein the classification is based at least in part on a channel used by the identified one or more wireless devices.

18. The method of claim 2, wherein the identified one or more wireless devices is not associated with the AP.

19. The method of claim 2, wherein the identified one or more wireless devices and the another wireless device are associated with different APs.

20. The method of claim 1, wherein the received information is transmitted by another AP, the AP and the another AP being associated with different BSSs.

21. An apparatus for coordinating access to a shared medium between an access point (AP) in a first basic service set (BSS) and an access point (AP) in a second basic service set (BSS), each BSS including one or more wireless devices, comprising:
means for receiving information at one of the APs associated with the first or second BSSs; and
means for modifying the use of the shared medium by one or more wireless devices to reduce the likelihood that the one or more wireless devices is subject to interference.

22. The apparatus of claim 21, further comprising:
means for determining whether one or more wireless devices is subject to interference with another wireless device in the wireless network; and
means for identifying the one or more wireless devices that is subject to interference.

23. The apparatus of claim 21, wherein the received information relates to one or more of a time, a frequency, a space, or a power for using the shared medium.

24. The apparatus of claim 21, wherein the means for receiving comprises a receiver and the means for modifying comprises a processor.

25. A non-transitory computer-readable medium comprising code that, when executed, causes an apparatus to:
receive information at one of the APs associated with the first or second BSSs; and
modify the use of the shared medium by one or more wireless devices to reduce the likelihood that the one or more wireless devices is subject to interference.

26. The non-transitory computer-readable medium of claim 25, wherein the code, when executed, further causes the apparatus to determine whether one or more wireless devices is subject to interference with another wireless device in the wireless network.

27. The non-transitory computer-readable medium of claim 25, wherein the code, when executed, further causes the apparatus to identify the one or more wireless devices that is subject to interference.

28. An apparatus for coordinating access to a shared medium between an access point (AP) in a first basic service set (BSS) and an access point (AP) in a second basic service set (BSS), each BSS including one or more wireless devices, comprising:
a receiver configured to receive information associated with the first or second BSSs; and
a controller configured to modify the use of the shared medium by the one or more wireless devices to reduce the likelihood that the identified one or more wireless devices is subject to interference.

29. The apparatus of claim 28, further comprising a classifier unit configured to determine whether one or more wireless devices is subject to interference with another wireless device in the wireless network.

30. The apparatus of claim 29, wherein the classifier unit is further configured to identify the one or more wireless devices that is subject to interference.
